(19) United States
(12) Patent Application Publication
(10) Pub. No.: US 2008/0257471 A1
(43) Pub. Date: Oct. 23, 2008

(54) Fixing a Surface Element on a Tire Via a Fabric

(75) Inventors: Alain Cottin, Clermont-Ferrand (FR); Georges Peyron, Riom (FR)

Correspondence Address: COHEN, PONTANI, LIEBERMAN & PAVANE LLP, 551 FIFTH AVENUE, SUITE 1210, NEW YORK, NY, 10176, US

(73) Assignee: Michelin Recherche et Technique S.A., Granges-Paccot (CH)

(21) Appl. No.: 11/631,470

(22) PCT Filed: Jun. 10, 2005
(86) PCT No.: PCT/EP05/06232

§ 371 Date: Aug. 27, 2007

(30) Foreign Application Priority Data
Jul. 1, 2004 (FR) 0407325

(51) Int. Cl. B60C 13/00

(52) U.S. Cl. 152/524

(57) ABSTRACT

A tire (1) comprising over at least part of its surface at least one applique (8). The applique (8) includes a first layer (9) in contact with the air and constituting the upper layer of the applique, and a second layer (10) in contact with the tire (1) and constituting the lower layer of the applique (8), said lower layer (10) of the applique including a bielastic fabric. The fabric used is preferably a bielastic knitted fabric, that is to say a mesh fabric of which the loops which form the mesh are capable of moving relative to one another in the knit direction and perpendicular to the knit direction.

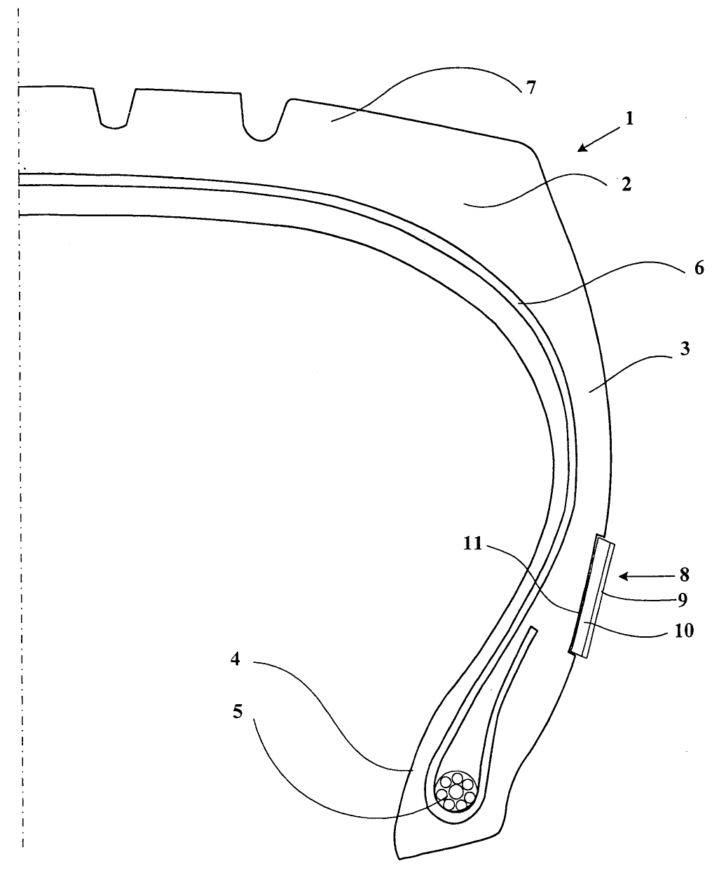

The invention relates to the application of appliques and/or elements to the surface of rubber articles, in particular tires. More particularly, it relates to the application of said elements and/or coatings after vulcanisation of said articles. The invention relates in particular to the marking, coloured or not, of part of the surface of a tire by application of a rigid or non-rigid element and/or of a coating.

For decorative or identification purposes, tires may exhibit marking, which may or may not be coloured, applied directly to a part generally of the external surface of the tire. “Marking” is to be understood to mean in this text any element or coating affixed to said surface of the tire, generally after vulcanisation thereof. This marking may consist of a “rigid” element, a soft element, a coat of lacquer, a coat of paint, etc.

“Rigid element” is to be understood to mean elements incapable of following the successive deformations of a tire when travelling. Depending on the individual circumstances, these “rigid” elements may be totally non-deformable or alternatively flexible but not resilient on the same scale as tire deformation. In other words, they may bend, if applicable, but be incapable of following the local variations of the surface area of the tire resulting from changes in the radii of curvature of said tire. These elements may consist of metal, plastics material, elastomeric material, ceramic material, etc.

The marking on a tire, carried out in a suitable material, may be in one or more colours, including white.

However, there are considerable difficulties involved in producing markings, coloured or not, on tires.

Such markings are intended to cover at least part of the tire surface. Inasmuch as such markings are intended as surface coverings, they are more particularly intended to cover tire casing surfaces known as “non-wearing”, that is to say which are not in contact with the road when said tires are used under normal conditions. Thus, such coloured markings, which are used in particular for decorative and identification purposes, may constitute at least in part the outer surface of a tire casing sidewall or the bottoms of tread patterns.

The complexity of coating the surface of tires directly with such markings is well known to the person skilled in the art. In effect, there are two major difficulties involved in this procedure, on the one hand the nature of the compositions in the tire, which, as will be seen more explicitly hereafter, has an effect on the markings and, on the other hand, the stresses to which the tire is subject during travel, which cause considerable deformation of the tire and thus of its surface, to which the markings must be able to adapt.

Vulcanised diene rubber compositions, both natural and synthetic, are liable, due to the presence of double bonds on their molecular chains, to deteriorate more or less rapidly after prolonged exposure to the atmosphere, as a result of known oxidation and ozonolysis mechanisms. These degradation mechanisms are further accelerated by the additional action of heat by thermo-oxidation, or alternatively of light by photo-oxidation (see for example: “Photo-oxidation and stabilisation of polymers”, Trends in Polym. Sci., Vol. 4, No. 3, 1996, 92-98; “Degradation mechanisms of rubbers”, Int. Polym. Sci. and Technol., Vol 22, No 12, 1995, 47-57).

Thanks to the development and introduction into diene rubber compositions designed for tire manufacture of various antidegradation agents, such as antioxidants or antiozonants, it has been possible gradually to inhibit all these tire degradation phenomena, which are associated with tire ageing. Compounds have even been found which are able simultaneously to fulfil both these functions; the most effective, both as antioxidants and antiozonants, are in known manner derivatives of quinoline, such as, for example 2,2,4-trimethyl-1,2-dihydroquinoline (“TMQ”) or derivatives of p-phenylenediamine (“PPD”), which are even more active than the former, such as for example N-(1,3-dimethylbutyl)-N′-phenyl-p-phenylenediamine. (“6 PPD”) or N-isopropyl-N′-phenyl-p-phenylenediamine (“IPPD”). These antidegradation agents TMQ and PPD are now very widespread, being used virtually systematically, sometimes even in combination, in conventional diene rubber compositions filled at least in part with carbon black, which gives them their characteristic black colour. However, the above-mentioned agents, and in particular the TMQ and PPD derivatives, are not photostable and, on exposure to UV radiation, generate coloured chemical species which cause deterioration of the colour of the rubber compositions containing them, staining them dark brown.

Furthermore, the antidegradation agents are mobile on a molecular scale within the rubber composition containing them. This mobility extends to the compositions adjacent to that initially containing the antidegradation agents. Thus, these antidegradation agents are liable to migrate into a coloured marking composition affixed to the rubber composition containing them and to stain it.

Furthermore, to limit degradation due to ozone, the elastomeric compositions also commonly incorporate waxes which provide additional protection, under static conditions, with regard to the antiozonants by forming a protective coating at the surface. However, the waxes, which are also distinguished by their ability to migrate to the surface of rubber articles, modify the external appearance of the surfaces of the elastomeric compositions by staining them or by making them dull and grey. This phenomenon is known as “efflorescence” of the waxes.

The above paragraphs explain why it is a very complex process to produce marking of a durable appearance, coloured or not, which is designed to cover part of the outer surface of tire casings and to be resistant to stains and to deterioration due to the antioxidants, antiozonants and waxes present in the elastomeric compositions used in tires.

Most of the solutions propose the development of coloured marking whose composition brings together the various constituents allowing coloration and preventing the migration of waxes or of staining products. However, as has been stated it is also necessary for the marking to be capable of enduring the mechanical stresses to which the tire is subject.

The solutions to these two problems which are now attainable are frequently incompatible and are therefore unsatisfactory when it comes to improving the compromise between durable appearance and resistance to mechanical stresses. In effect,
if the coating is sufficiently flexible to cope with the repeated deformations over the life of the tire, the molecular mobility therein is too great for migration of the staining products to be wholly prevented;
if the coating is rigid, so curbing molecular mobility, it is no longer capable of following the deformations of the tire without causing excessive concentrations of stress which, depending on individual circumstances, result in detachment or tearing of the coating.

To obtain durable marking, it is thus necessary to find a way of at least reducing, if not eliminating, deterioration of the colour and/or of the brightness of the marking affixed to the external surface of a tire, while imparting to it an ability to conform to the deformations of the tire.

The applicant has surprisingly discovered that a different way of solving both the chemical problem and the mechanical problem associated with marking a tire consists in interposing between the part of the tire surface to be marked and the marking element and/or coating a layer of fabric, in particular of bielastic knitted fabric. The layer of bielastic knitted fabric and the marking element and/or coating thus form a marking stack known hereinafter as an applique.

Furthermore, it is increasingly desired to store information on electronic chips integrated in or attached to the tire, and to perform measurements such as in particular pressure and/or temperature monitoring which require the use of sensors or of other connection, communication, or signal transmitting or receiving systems. Such devices, which require rigid supports, are very difficult to attach to the tire since they cannot follow the deformations of the tire.

For this reason, the solution provided by the invention also makes it possible to overcome the problems involved in attaching such devices to the tire.

Consequently, the invention firstly provides a tire comprising at least one applique over at least part of its surface, characterised in that said applique is composed of a first layer in contact with the air constituting the upper layer of the applique and a second layer in contact with the tire constituting the lower layer of the applique, said lower layer of the applique consisting of a bielastic fabric. The fabric used is a bielastic knitted fabric, that is to say a mesh fabric of which the loops which form the mesh are capable of moving relative to one another in the knit direction and perpendicular to the knit direction.

Bielastic means that the material in question exhibits properties which render it elastic in at least two substantially perpendicular directions, and preferably in all directions.

It is therefore not essential to use elastomeric fibres to produce this fabric or knit. Indeed, use thereof would be inadvisable if the principle aim is to prevent migration. It is optionally possible to add a little thereof to assist in implementation and to promote elastic recovery.

If, however, only mechanical decoupling is required, the use of an elastomeric matrix may make it possible to increase decoupling capacity.

The term “bielastic fabric” covers structures which are capable of deforming elastically, in reversible manner, but which are not necessarily obtained by knitting. These structures may in particular be obtained by crochet or they may be assemblies in the form of plush loops or needled structures.

The solution provided by the inventors of interposing an elastic knitted fabric between the surface of the tire and the marking element and/or coating allows chemical decoupling, to prevent chemical exchanges by migration and thus staining of said coating and/or element without it being necessary for the latter itself to exhibit impermeability characteristics, and at the same time the achievement of mechanical decoupling so as to allow said coating and/or element to remain attached and to keep its shape.

The interlacing of the loops forms a network which is elastically deformable in two substantially perpendicular directions. In the advantageous case where a bielastic knitted fabric is used, the capacity of this bielastic knitted fabric according to the invention to deform results in particular from the knitted structure, the fibres constituting the knitted fabric sliding relative to one another in the mesh network. In general, the rate of elastic elongation of the bielastic knitted fabric according to the invention is at least 10% in at least one of the two elongation directions. It is advantageously 50% or more, or indeed more particularly 100% or more.

The direction in which the bielastic knitted fabric is laid over the zones to be protected is advantageously such that the direction of the knitted fabric having the greater elongation rate is parallel to the direction in which the greatest stress acts on said zone.

The bielastic fabric exhibits at least one and preferably all of the following characteristics:

a) an elastic elongation rate of at least 8%,
b) a mesh size less than or equal to 150 loops per decimetre, and preferably 200 loops per decimetre.

For example, tests performed with a knitted fabric comprising 240 loops per decimetre on one side and 235 loops per decimetre on the other side allowed very interesting results to be obtained, in particular in terms of resistance to cracking.

In general, the bielastic knitted fabric according to the invention is made up of synthetic fibres, natural fibres or a mixture of these fibres. By way of synthetic fibres, the bielastic knitted fabric according to the invention may comprise at least one type of fibres selected from among polyamide 6, polyamide 6.6 (nylon), polyesters etc.

Thus, advantageously, said fabric comprises at least one material selected from among polyamides, polyesters, rayon, cotton, wool, aramid, silk and linen.

According to one advantageous variant embodiment, a certain proportion of elastic yarns of materials such as polyurethane, latex, natural or synthetic rubber may prove useful in ensuring the elastic ratio, which makes it possible to facilitate implementation of the fabric. Thus, by way of bielastic knitted fabric according to the invention, mention may be made of the knitted fabric sold by Milliken under reference no. 2700 and composed of 82% polyamide 6 fibre and 18% 44 dTex polyurethane.

Said fabric is advantageously preglued with an adhesive system. According to one example of embodiment, said fabric is preglued with an adhesive system for example of the RFL type (resorcinol formaldehyde latex).

The fabric or bielastic knitted fabric according to the invention may be used in the untreated form, but for better adhesion to the rubber structure to which it is affixed it is preferable to use it in the form of a preglued knitted fabric. The composition impregnating the fabric or knitted fabric is generally a composition compatible with rubber. That is to say that the impregnating composition is capable of co-vulcanising with a rubber composition, so ensuring good cohesion between said rubber composition and the bielastic knitted fabric. The impregnating composition according to the invention may be a resin, such as in particular a resin of the RFL type (resorcinol formaldehyde latex).

The applique is advantageously attached to the tire by insertion in a cavity of a suitable size formed to this end at the surface of the tire.

The applique is attached to a part of the surface which is radially to the outside of the tire.

The fabric or bielastic knitted fabric according to the invention exhibits a thickness which may be between 0.2 mm and 2 mm, and preferably between 0.4 and 1.2 mm.

Its mass per unit area is generally between 70 and 700 g/m2, and preferably between 140 and 410 g/m2.

The applique is attached to a part of the surface which is radially to the inside of the tire.

According to one variant embodiment, the bielastic knitted fabric is composed of at least one polymer selected from among thermosetting and thermoplastic polymers.

According to one advantageous embodiment, the upper layer of the applique comprises at least one material selected from among coloured or uncoloured plastics, elastomeric, ceramic and metallic materials.

According to another advantageous embodiment, the upper layer of the applique consists of a coating of paint or a coat of lacquer, coloured or not.

According to another advantageous embodiment, the upper layer of the applique comprises an element selected in particular from among sensors, electronic chips, supply harnesses, connectors, receiving antennas and transmitting antennas.

According to another advantageous variant, the upper layer of the applique may also be a visual motif, configured on a material of the elastomeric or diene rubber type, i.e. an elastomer based at least in part on diene monomers, this motif exhibiting at least one colour other than the black colour of the rubber-based material. Such a motif comprises, on its outer surface, at least one light diffraction network formed by a plurality of ribs or grooves of the height H disposed in parallel with one another at a pitch P.

Preferably, the pitch P is less than or equal to 1.5 microns and the height H is at most equal to 1 micron, since the diffraction effect disappears beyond these limit values. More preferably, H is between 0.1 and 0.3 microns and P is between 0.5 and 0.7 microns; even more preferably, H is between 0.17 and 0.23 microns and P is equal to 0.6 microns. These parameters may advantageously be determined as a function of the optical index of the material on which said motif is formed.

The presence of fabrics is particularly important for this type of embodiment, since it has been observed that waxes and antiozonants or antioxidants have a tendency to migrate and to form a protective layer on the outer surface of the tire. The presence of such a layer reduces the optical effect produced by the diffraction network. The presence of the fabric protects the motif from this type of migration, and the motif maintains its visual properties.

The invention also relates to a process for marking a part at least of the surface of a tire, comprising the following steps:
affixing the marking to the upper surface of a layer of bielastic knitted fabric of suitable size forming an applique,
attaching said applique, by adhesive bonding of the lower surface of said layer of bielastic knitted fabric, to the part of the surface of the tire to be marked.

The marking preferably comprises at least one element of a material selected from among coloured or uncoloured plastics, elastomeric, ceramic and metallic materials.

Otherwise, it may comprise at least one coating selected from among a coat of paint or a coat of lacquer, coloured or not.

The invention also provides a process for attaching a rigid element to a part at least of the surface of a tire, comprising the following steps:
attaching the rigid element to the upper surface of a layer of bielastic knitted fabric of suitable size, thus forming an applique,
attaching said applique, by adhesive bonding of the lower surface of the layer of bielastic knitted fabric, to the desired part of the surface of the tire.

The rigid element preferably comprises at least one element selected in particular from among sensors, electronic chips, supply harnesses, connectors, receiving antennas, transmitting antennas and electronic circuits.

Other features and advantages of the invention will become apparent from reading the description of an example of embodiment of a tire according to the invention, made with reference to the appended drawing in which the single FIGURE shows half a radial section through a tire bearing a marking according to the invention, and from reading the description of the process of attaching to the tire a marking coating and/or element according to the invention.

In the text, the term “lower” will be used to designate any layer or surface oriented radially towards the tire and “upper” will be used to designate any layer or surface oriented radially away from the tire, in particular a layer or surface in contact with the air.

Marking a tire constitutes one aspect of the invention. This aspect is described here purely by way of example and does not in any way limit the invention. The person skilled in the art will understand that the invention also comprises attaching to the surface of the tire an element and/or a coating intended for other purposes than marking, such as the attachment of monitoring devices, measuring devices, etc.

Thus, by way of example, the appended FIGURE is a schematic representation of half a radial section of a tire 1 with carcass reinforcement. In the FIGURE this tire 1 comprises a crown 2, a sidewall 3, a bead 4 and a carcass reinforcement 6 extending from one bead to the other. The crown 2 is surmounted by a tread 7. The carcass reinforcement 6 is wound around the two bead wires 5 (only one being represented in the half section shown in the FIGURE) within each bead 4.

The invention thus relates to a tire 1 comprising at least one applique 8 according to the invention over at least part of its surface. The part of the tire to which is attached the applique according to the invention exhibits a rubber composition based on at least one substantially saturated diene elastomer, at least one substantially unsaturated diene elastomer or alternatively a mixture of these two types of elastomers. The rubber composition may contain conventional additives and in particular agents providing protection against ozone, oxidation, etc.

“Diene” elastomer is understood to mean, in known manner, an elastomer arising at least in part (i.e. a homopolymer or a copolymer) from diene monomers (monomers bearing two double carbon-carbon bonds, whether conjugated or not). These diene elastomers may be classed in two categories: “substantially unsaturated” or “substantially saturated”.

In general, “substantially unsaturated” diene elastomer is understood here to mean a diene elastomer resulting at least in part from conjugated diene monomers, having a content of members or structural units of diene origin (conjugated dienes) which is greater than 15% (mol %).

Thus, for example, diene elastomers such as butyl rubbers or copolymers of dienes and of alpha-olefins of the EPDM (ethylene-propylene-diene terpolymer) type do not fall within the preceding definition, and may in particular be described as “substantially saturated” diene elastomers (low or very low content of structural units of diene origin which is always less than 15%).

According to a preferred embodiment of the invention, the part of the tire to which is attached the applique according to the invention is the sidewall of the tire. The appended FIGURE illustrates this embodiment and more particularly attachment of the applique 8 to the radially lower part of the sidewall 3. The composition of this part of the tire may then contain at least one substantially saturated diene elastomer, in particular at least one EPDM copolymer, whether or not this copolymer is used for example in a mixture with one or more of the substantially unsaturated diene elastomers.

According to another embodiment of the invention, the part of the tire to which is attached the applique according to the invention is an internal tire rubber or any other layer or item from the inner portion of the tire. The composition of this part of the tire may then contain at least one substantially saturated diene elastomer of the isobutene and isoprene copolymer type (butyl rubber), as well as halogenated versions of these copolymers.

According to yet another embodiment of the invention, the part of the tire to which is attached the applique according to the invention is the tread, in particular the bottoms of the tread pattern. The composition of this part of the tire may then contain at least one substantially unsaturated diene elastomer.

By reference to the FIGURE, the applique 8 according to the invention thus comprises a first layer 9 in contact with the air and constituting the upper layer of the applique and a second layer 10 in contact with the tire and constituting the lower layer of the applique. This lower layer 10 of the applique consists of a highly deformable elastic knitted fabric of low apparent density. It allows chemical and mechanical decoupling between the surface of the tire and the upper layer of the applique, constituting the marking element and/or coating.

The layer of elastic knitted fabric constituting the lower layer 10 of the applique 8 according to the invention consists of a low density elastic knitted fabric having an elevated void content. This provides elasticity by sliding of the threads and deformation of the mesh loops, and also opposition to chemical migration, so preventing or very greatly limiting migration of the staining agents contained in the elastomeric mixture constituting the part of the tire to which the tire applique is attached. In effect, the elevated void content and the low density bring about a reduction in the passage cross section and lengthen the path along the threads of the knitted fabric and throughout its thickness. Of course, this effect is also closely linked to the thickness of the elastic knitted fabric.

Limitation of staining agent migration may be reinforced by a judicious choice of the material constituting the elastic knitted fabric, which material may exhibit impermeability characteristics relative to migrating substances.

Furthermore, the advantage of an elastic knitted fabric is clearly that of having sufficient structural flexibility to follow the deformations of the tire.

It is thus possible to select different types of material to constitute this elastic knitted fabric, its thickness, its void content and its density being directly related to this choice and to the structure of the knitted fabric (thread diameter, number of loops per dm and degree of tightness).

In general, the layer of elastic knitted fabric may exhibit a thickness of at least 1 mm. Below this value, chemical and mechanical decoupling would not be sufficient to ensure marking which is durable with regard to its appearance and quality.

In general, when the applique is attached to a part of the radially outer surface of the tire, it may not protrude by more than 3 mm from the surface of the tire. In effect, an applique protruding from the tire 1 by more than this value of 3 mm would greatly increase the risk of said applique being torn out.

In general, when the applique is attached to a part of the radially inner surface of the tire, in particular to the internal rubber, it may exhibit a thickness which is much greater than 3 mm. However, too heavy a weight attached to the inside of the tire would have the consequence of unbalancing it to an excessive degree. Thus, the thickness of the applique also depends on the density of the elastic knitted fabric and on the nature of the upper layer. By way of example, it is nevertheless possible to envisage appliques with thicknesses of up to approximately 1 cm for attachment to a part of the radially inner surface of the tire.

According to one advantageous embodiment of the invention illustrated by the FIGURE, with a view to anchoring the applique 8 and thus achieving better attachment of said applique 8, the latter is attached in a cavity 11 of suitable size, formed to this end in the tire 1. This cavity, which exhibits a depth at most equal to the thickness of the applique 8, is advantageously formed during moulding of the tire 1.

Preferably, the elastic knitted fabric may exhibit a density of at least 0.02 g/cm3, measured in conventional manner.

The elastic knitted fabric may preferably exhibit a density of up to 0.50 g/cm3.

In general, the rigidity of the elastic knitted fabric will be advantageously less than the rigidity of the lowest rigidity material to be decoupled. Preferably, this difference must be at least 50%. Even more preferably, the rigidity of the elastic knitted fabric must be at least 3 times lower than the rigidity of the lowest rigidity material to be decoupled. The rigidity is expressed as the modulus of extension at 10% elongation, measured in conventional manner.

Another characteristic of the elastic knitted fabric which may be used in the context of the invention is its void content. In general, according to the invention the void content is advantageously at least 40% if the knitted fabric is to be sufficiently compressible. This void content may be calculated by comparing the density of the knitted fabric with that of the compact material constituting the matrix thereof, measured by any conventional means.

The knitted fabric constituting the lower layer of the applique according to the invention will have at least one of the characteristics defined above. It will advantageously have at least two of these characteristics and, more advantageously still, it will have the following characteristics:
a void content of at least 40%,
a thickness of at least 1 mm,
a density of from 0.02 g/cm3 to 0.5 g/cm3. (to be verified)

Nevertheless, the characteristics of the knitted fabric stated above also depend on the nature of the materials used to form this knitted fabric. The person skilled in the art will know how to determine which characteristics are required for a given material.

It is thus possible to select a bielastic knitted fabric for which a specific density of 0.05 to 0.40 g/cm3 represents a good working compromise.

Among the non-elastomeric materials which may constitute the matrices of these knitted fabrics, mention may be made of:
natural textile fibres, such as cotton, wool, linen, hemp, silk etc.
man-made textile fibres such as rayon;
synthetic textile fibres, for example polyesters, polyamides, aramids, polyvinyl chloride, polyolefins etc.
mineral fibres, for example glass, silica, or rock wool.

Elastomeric materials which may be mentioned are:
fibres of natural rubber, polybutadiene, SBR, polyurethane.

According to one variant embodiment, a skin covers the edge of the knitted fabric in order to prevent water penetration in the case of an applique affixed to the radially outer surface of the tire. This skin is formed during manufacture of the applique or applied later.

In the case of applications to the inside of the tire, in particular to the internal rubber, the knitted decoupling fabric must not have an outer skin so as not to be subject to compression by the inflation air.

The element and/or the coating constituting the upper layer 9 of the applique 8 to be affixed to the tire 1 may take the form:
of a flexible layer which it is desired to decouple chemically to prevent the migration of constituent agents of the rubber composition constituting the part of the tire to which the marking element and/or coating is affixed, and/or to decouple mechanically to prevent any delamination, cracking, etc. This may be a layer of elastomeric mix, coloured or not, a printed layer, etc.
of a substantially decorative rigid element, to be decoupled mechanically and optionally chemically. It may for example consist of a rigid coat of paint, a rigid coat of lacquer, coloured or not, a plate, a sheet, a knitted fabric, a web, a moulded object, a machined object etc., of any elastomeric, plastics, ceramic or metallic material, bare or decorated, which permits the selection of any motif or colour. It would seem advantageous to perform marking with “rigid” rather than soft elements, on the one hand because it is possible to obtain objects of durable appearance by stamping, injection, etc. The rigidity of these objects substantially diminishes molecular mobility.
of a rigid functional element such as for example in particular one which comprises an electronic device, such as a sensor, an antenna or a layer of connecting wires allowing the tire to receive or transmit information, with or without a contacting patch. The contacting patch is understood to mean the tablet or base, generally of elastomer, to which these elements are attached, in detachable or non-detachable manner, and which permits the assembly to be attached to the tire. Such elements are known to the person skilled in the art.

Mention may be made of by way of example of the elements described in EP 1 254 787, US 2002 0124934, EP 1 006 167.

The process of marking a part at least of the surface of a tire 1 according to the invention comprises the following steps:
affixing the marking 9 to the upper part of a layer of knitted fabric 10 of suitable size thus forming a stack known as an applique 8,
attaching said applique 8, by adhesive bonding of the lower part of said layer of knitted fabric 10, to the part of the surface of the tire 1 to be marked.

Affixing of the marking, element and/or coating means attaching this marking to the knitted fabric by any suitable means, such as in particular by transfer, adhesive bonding, thermal bonding, etc.

The process of attaching a rigid element, other than a marking, to a part at least of the surface of a tire is similar. It comprises the steps of attaching the rigid element, generally by adhesive bonding, to the upper part of a layer of knitted fabric of suitable size forming an applique, and of attaching said applique, by adhesive bonding of the lower part of the layer of knitted fabric, to the desired part of the tire surface.

Various adhesive bonding processes may be used for adhesive bonding of the layer of knitted fabric 10 to the surface of the tire 1, as well as for adhesive bonding of the upper layer 9 of the applique 8 (marking or other element to be attached) to the layer of knitted fabric 10.

To bond the knitted fabric adhesively to the surface of the tire, the adhesive must be elastomeric in order to be able to follow the deformations of the tire.

For bonding the upper layer 9 of the applique 8 adhesively to the layer of knitted fabric 10, the rigidity of the adhesive is less important because the upper surface of the layer of knitted fabric 10 in contact with the upper layer 9 of the applique 8 is deformed only slightly or not at all.

To simplify positioning, it is advantageously possible to use a single adhesive which makes it possible to form a thermally reactivatable adhesive surface.

For example, it is possible to use a self-crosslinking polyurethane latex such as that sold by AVECIA under the trade name “NEO-REZ R-550”, by depositing the latter on each of the surfaces to be joined (tire surface, the two surfaces of the layer of knitted fabric and the lower surface of the upper layer of the applique). It should be noted that, for those surfaces which do not have directly polar functions which are capable of bonding chemically with polyurethane, it is necessary to provide intermediate treatment, for example with a 2 or 3% solution based on trichloroisocyanuric acid (TIC) in an organic solvent, generally ethyl acetate.

The surface of the vulcanised tire is thus subjected to a treatment to render it polar and to functionalize said surface's elastomers. At least one coat consisting of an aqueous dispersion of polyurethane is applied to said treated surface and said coat is left to dry. Application of the aqueous dispersion of polyurethane may be performed at ambient temperature. Thus, this process may easily be implemented on the vulcanised tire without the additional need for heating, although it is possible by a moderate increase in the temperature at the surface of the tire to accelerate the drying operations.

It is also possible to use an acrylic adhesive or polychloroprene.

With a sufficiently tight knitted fabric, it may be feasible to position the knitted fabric or the applique on the uncured tire, so that, on curing, the tire mixes penetrate to a certain thickness and ensure mechanical anchoring.

In this case, it is also possible to imagine pregluing the knitted fabric by means of an adhesive conventional in the tire industry, of the RFL (resorcinol/formaldehyde/latex) type for example, so as to reinforce the mechanical anchoring.

1. A tire (1) comprising over at least part of its surface at least one applique (8), wherein the applique comprises:
a first layer (9) in contact with the air and constituting the upper layer of the applique; and
a second layer (10) in contact with the tire (1) and constituting the lower layer of the applique (8), said lower layer (10) of the applique consisting of a bielastic fabric, in which the fabric used is a bielastic knitted fabric.

2. The tire according to claim 1, in which the bielastic fabric exhibits at least one of the following characteristics:
an elastic elongation rate of at least 8%; and
a mesh size less than or equal to 150 loops per decimetre, and preferably 200 loops per decimetre.

3. The tire according to claim 1, in which said fabric comprises at least one material selected from among polyamides, polyesters, rayon, cotton, wool, aramid, silk and linen.

4. The tire according to claim 1, in which the fabric comprises a certain proportion of elastic yarns.

5. The tire according to claim 1, in which said fabric is preglued with an adhesive system.

6. The A tire according to claim 1, wherein of the applique (8) is attached to the tire (1) by insertion in a cavity (11) of a suitable size formed to this end at the surface of the tire.

7. The tire according to claim 1, wherein the applique (8) is attached to a part of the radially outer surface of the tire.

8. The tire according to claim 1, wherein the fabric or knitted fabric exhibits a thickness which may be between 0.2 mm and 2 mm, and preferably between 0.4 and 1.2 mm.

9. The tire according to claim 1, wherein the fabric or knitted fabric exhibits a mass per unit area generally between 70 and 700 g/m2, and preferably between 140 and 410 g/m2.

10. The tire according to claim 1, wherein the bielastic knitted fabric is composed of at least one polymer selected from among thermosetting and thermoplastic polymers.

11. The tire according to claim 1, wherein the upper layer (9) of the applique (8) comprises at least one material selected from among coloured or uncoloured plastics, elastomeric, ceramic and metallic materials.

12. The tire according to claim 1, wherein the upper layer (9) of the applique (8) includes a coating of paint or a coat of lacquer, coloured or not.

13. The tire according to claim 1, wherein the upper layer (9) of the applique (8) comprises an element selected in particular from among sensors, electronic chips, supply harnesses, connectors, receiving antennas and transmitting antennas.

14. A process of marking a part at least of the surface of a tire (1), wherein the process comprises steps of:
affixing the marking (9) to the upper surface of a layer of bielastic knitted fabric (10) of suitable size forming an applique (8); and
attaching said applique (8), by adhesive bonding of the lower surface of said layer of bielastic knitted fabric (10), to the part of the surface of the tire (1) to be marked.

15. The marking process according to claim 14, wherein the marking (9) comprises at least one element of a material selected from among coloured or uncoloured plastics, elastomeric, ceramic and metallic materials.

16. The marking process according to claim 14, wherein the marking (9) comprises at least one coating selected from among a coat of paint or a coat of lacquer, coloured or not.

17. A process of attaching a rigid element to at least a part of the surface of a tire, wherein the process comprises the steps of:
attaching the rigid element to the upper surface of a layer of bielastic knitted fabric of suitable size, thus forming an applique; and
attaching said applique, by adhesive bonding of the lower surface of the layer of bielastic knitted fabric, to the desired part of the surface of the tire.

18. The process of attaching a rigid element according to claim 17, wherein the rigid element comprises at least one element selected in particular from among sensors, electronic chips, supply harnesses, connectors, receiving antennas, transmitting antennas and electronic circuits.

19. The tire according to claim 1, wherein said bielastic knitted fabric is, i.e., a mesh fabric of which the loops which form the mesh are capable of moving relative to one another in the knit direction and perpendicular to the knit direction.
